(19) United States
(12) Patent Application Publication
(10) Pub. No.: US 2025/0004209 A1
(43) Pub. Date: Jan. 2, 2025

(54) OPTICAL FIBER FIXING STRUCTURE AND OPTICAL FIBER GUIDING DEVICE COMPRISING THE OPTICAL FIBER FIXING STRUCTURE

(71) Applicant: BKS TEC CORP., HSINCHU CITY (TW)

(72) Inventors: CHENG HSIANG CHEN, HSINCHU CITY (TW); KO WEI LEE, HSINCHU CITY (TW); HSIN TSE TSAI, HSINCHU CITY (TW)

(21) Appl. No.: 18/743,797

(22) Filed: Jun. 14, 2024

Related U.S. Application Data
(60) Provisional application No. 63/511,288, filed on Jun. 30, 2023.

(51) Int. Cl. G02B 6/36; G02B 6/245; G02B 6/25

(52) U.S. Cl. CPC G02B 6/3616; G02B 6/245; G02B 6/25

(57) ABSTRACT

An optical fiber fixing structure is provided. The optical fiber fixing structure includes a body and a fixing element. One or more transition recesses and one or more positioning recesses are formed on the body. The fixing element includes a rod, one or more tapered holes and a clamping element. The rod is rotatably disposed on the body. One or more tapered holes are configured to guide one or more optical fibers from the one or more transition recesses to the one or more positioning recesses when the rod is configured in a first state. The clamping element is configured to clamp the one or more optical fibers between the clamping element and the one or more positioning recesses when the rod is configured in a second state.

### CROSS-REFERENCE TO RELATED APPLICATION

The present application claims priority to U.S. Provisional Application No. 63/511,288, filed on Jun. 30, 2023, which is incorporated by reference herein in its entirety.

### TECHNICAL FIELD

The present disclosure is related to an optical fiber fixing structure, and, in particular, to an optical fiber guiding device using an optical fiber fixing structure to connect one or more optical fibers to a fiber connector.

### BACKGROUND

In the field of fiber-optic communications, connection accuracy between the fiber connector and the optical fiber is essential for efficient transmission of the optical signal. As demand for fiber-optic applications increases, thinner and thinner optical fibers are being developed. When multiple optical fibers are installed in a fiber connector, it is crucial to align the ends of the fibers. As the optical fibers become thinner, perforations of the fiber connector become denser.

Efficient transmission of the optical signal is directly related to precise assembly of the fiber connectors and the optical fibers. Therefore, it is important to ensure assembly efficiency and accuracy when assembling the fiber connector and the optical fibers.

### BRIEF SUMMARY OF THE DISCLOSURE

One aspect of the present disclosure provides an optical fiber fixing structure. The optical fiber fixing structure includes a body and a fixing element. One or more recesses are formed on the body. The fixing element includes a rod, one or more tapered holes, and a clamping element. The rod is rotatably disposed on the body. One or more tapered holes are configured to guide one or more optical fibers to the one or more recesses when the rod is configured in a first state. The clamping element is configured to clamp the one or more optical fibers between the clamping element and the one or more recesses when the rod is configured in a second state.

Another aspect of the present disclosure provides an optical fiber guiding device. The optical fiber guiding device includes an optical fiber fixing structure, a stripping device, and a fiber inserting device. The optical fiber fixing structure includes a body and a fixing element. One or more transition recesses and one or more positioning recesses are formed on the body. The fixing element includes a rod, one or more tapered holes, and a clamping element. The rod is rotatably disposed on the body. The one or more tapered holes are configured to guide one or more optical fibers from the one or more transition recesses to the one or more positioning recesses when the rod is configured in a first state. The clamping element is configured to clamp the one or more optical fibers between the clamping element and the one or more positioning recesses when the rod is configured in a second state. The stripping device is configured to strip a cover layer off the one or more clamped optical fibers. The fiber inserting device is configured to align and move a fiber connector toward the one or more optical fibers so that the one or more optical fibers are inserted into the fiber connector after the cover layer is stripped off the clamped optical fibers.

In some embodiments, the rod includes two opposite ends, and the rod is connected to the body by insertion of the two opposite ends of the rod into two pivot holes of the body, respectively.

In some embodiments, the one or more recesses include one or more transition recesses and one or more positioning recesses, and a number of the one or more transition recesses is equal to a number of the one or more positioning recesses.

In some embodiments, a number of the one or more tapered holes is less than the number of the one or more transition recesses.

In some embodiments, each of the one or more transition recesses connects to exactly one of the one or more positioning recesses.

In some embodiments, a spacing of the transition recesses is equal to a spacing of the positioning recesses.

In some embodiments, the clamping element includes a material with a high friction coefficient.

In some embodiments, the clamping element is separated from the body when the rod is configured in the first state, and the clamping element is in contact with the body when the rod is configured in the second state.

In some embodiments, the one or more optical fibers are surrounded by a cable jacket.

In some embodiments, the stripping device is configured to strip the cover layer off the clamped optical fibers to expose a core of the one or more optical fibers.

In some embodiments, the optical fiber guiding device further includes a dispensing device and a cutting device. The dispensing device is configured to fix the one or more optical fibers on the fiber connector. The cutting device is configured to cut the one or more optical fibers after the one or more optical fibers are fixed on the fiber connector.

In some embodiments, the dispensing device is configured to apply an adhesive to the fiber connector, so as to fix the one or more optical fibers on the fiber connector.

In some embodiments, the adhesive is a photo-curable adhesive.

In some embodiments, the cutting device is configured to cut the core of the one or more optical fibers with a controlled endface angle.

In the present disclosure, the optical fiber fixing structure is configured to clamp the one or more optical fibers to provide high-precision positioning and good stress control of the one or more optical fibers. The optical fiber guiding device is configured to automatically connect the one or more optical fibers clamped by the optical fiber fixing structure to the fiber connector, thereby improving assembly efficiency and accuracy when assembling the fiber connector and the optical fibers.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiments disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a front perspective view of an optical fiber fixing structure according to some embodiments of the present disclosure.

FIG. 1B is a rear perspective view of the optical fiber fixing structure according to some embodiments of the present disclosure.

FIG. 2A is a front perspective view of a fixing element according to some embodiments of the present disclosure.

FIG. 2B is a rear perspective view of the fixing element according to some embodiments of the present disclosure.

FIG. 3A is a partial enlarged view of a region of the optical fiber fixing structure in FIG. 1A according to some embodiments of the present disclosure.

FIG. 3B is a partial enlarged view of a region of the optical fiber fixing structure in FIG. 1B according to some embodiments of the present disclosure.

FIG. 3C is a schematic diagram illustrating the region of the optical fiber fixing structure in FIG. 3B with the fixing element removed according to some embodiments of the present disclosure.

FIG. 4A is a front perspective view of the optical fiber fixing structure when a rod is configured in a second state according to some embodiments of the present disclosure.

FIGS. 4B and 4C are rear perspective views of the optical fiber fixing structure when the rod is configured in the second state according to some embodiments of the present disclosure.

FIG. 5A is a partial enlarged view of a region of the optical fiber fixing structure in FIG. 4A according to some embodiments of the present disclosure.

FIG. 5B is a partial enlarged view of a region of the optical fiber fixing structure in FIG. 4B according to some embodiments of the present disclosure.

FIG. 6 is an optical fiber guiding device according to some embodiments of the present disclosure.

FIG. 7A and FIG. 7B show different phases of operations of connecting optical fibers to a fiber connector in the optical fiber guiding device of FIG. 6 according to some embodiments of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another element, component, region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limited to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

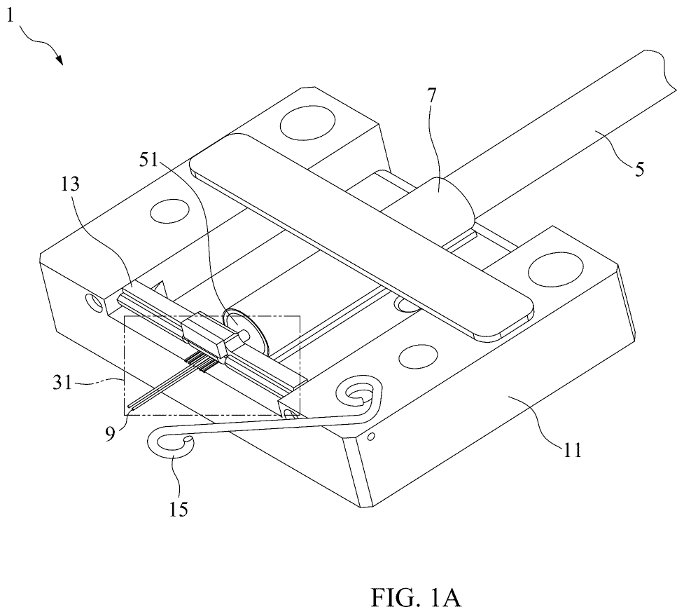

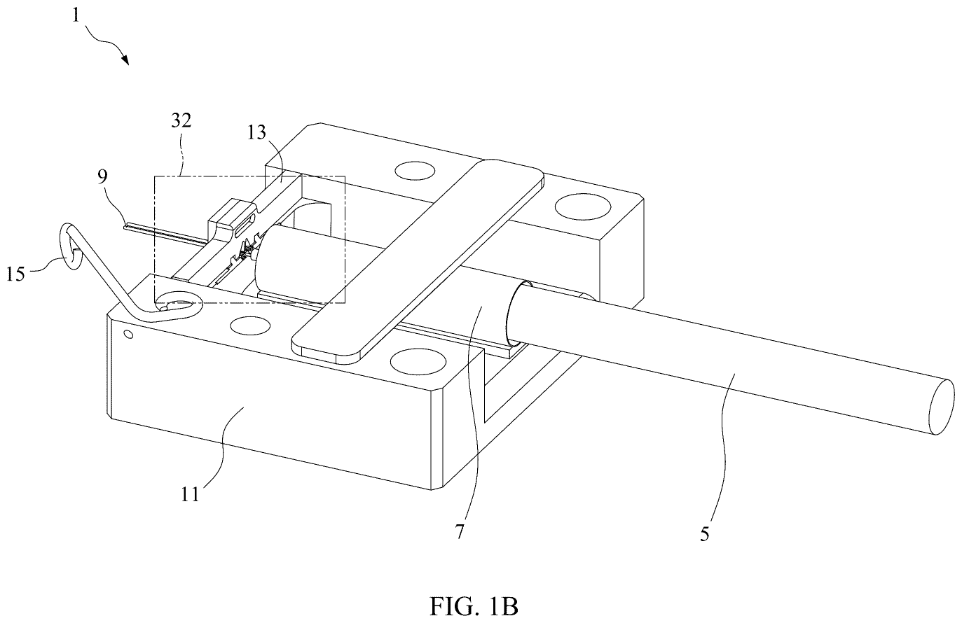

FIG. 1A is a front perspective view of an optical fiber fixing structure 1 according to some embodiments of the present disclosure, and FIG. 1B is a rear perspective view of the optical fiber fixing structure 1 according to some embodiments of the present disclosure. The optical fiber fixing structure 1 includes a body 11 and a fixing element 13. The body 11 is an insulating body. In some embodiments, the body 11 includes a pipe (or a tube) 7. The optical fiber fixing structure 1 is capable of fixing a cable 5 by the fixing element 13 when the cable 5 is inserted into the pipe 7. The cable 5 includes a cable jacket 51 and one or more optical fibers 9 surrounded by the cable jacket 51. In some embodiments, the optical fibers 9 are multi-mode optical fibers (MMFs) used for short-distance communication. In some embodiments, the optical fibers 9 are single-mode optical fibers (SMFs) used for long-distance communication. In some embodiments, the optical fiber fixing structure 1 further includes an auxiliary element 15. The auxiliary element 15 is rotatable and is configured to assist in securing the fixing element 13. In some embodiments, the auxiliary element 15 is a spring clip. To simplify the description, other components (elements) in the optical fiber fixing structure 1 are omitted.

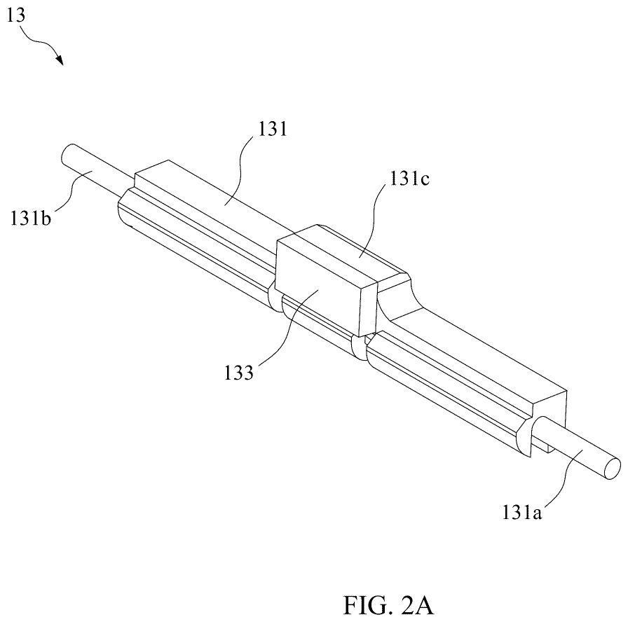

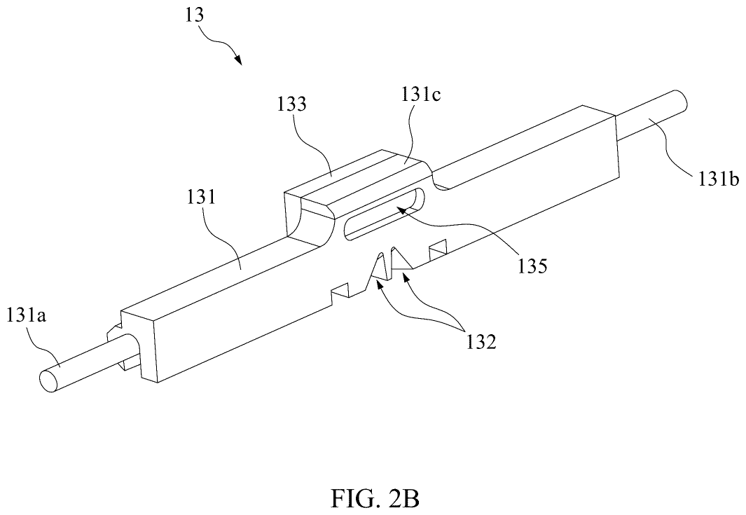

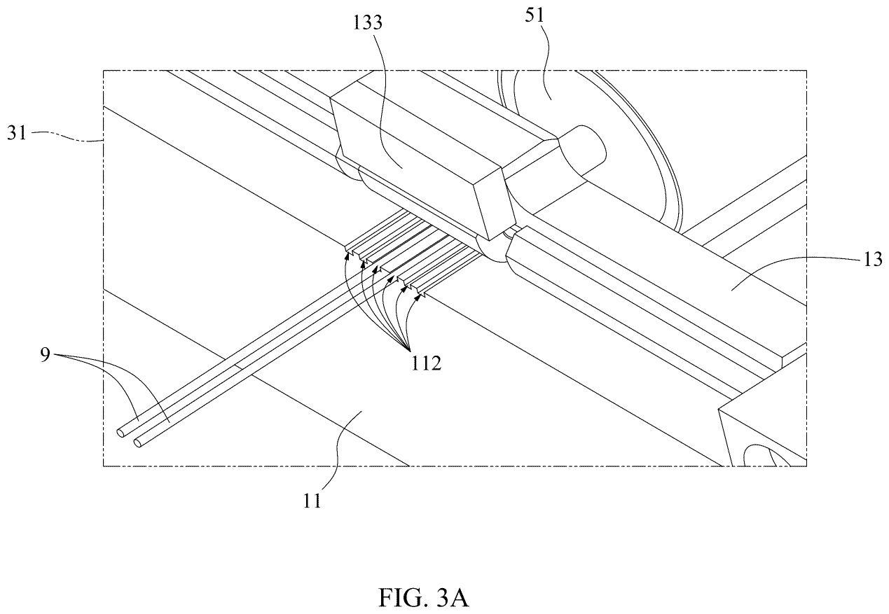

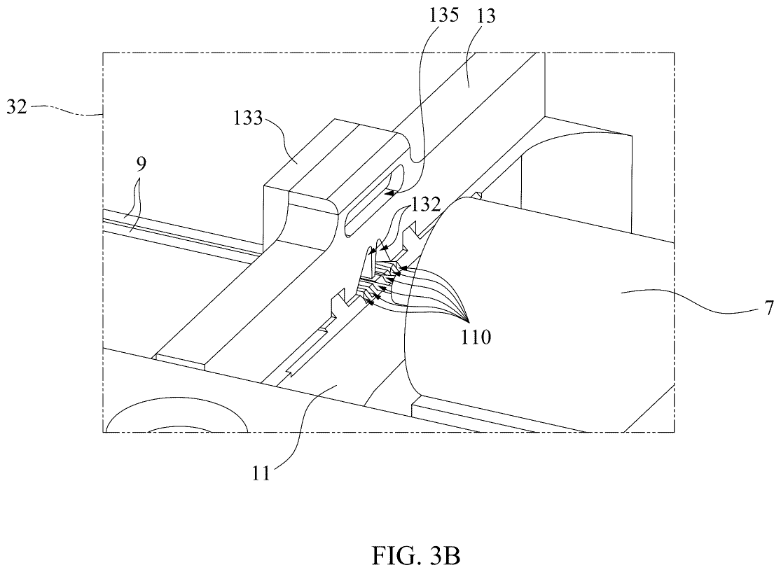

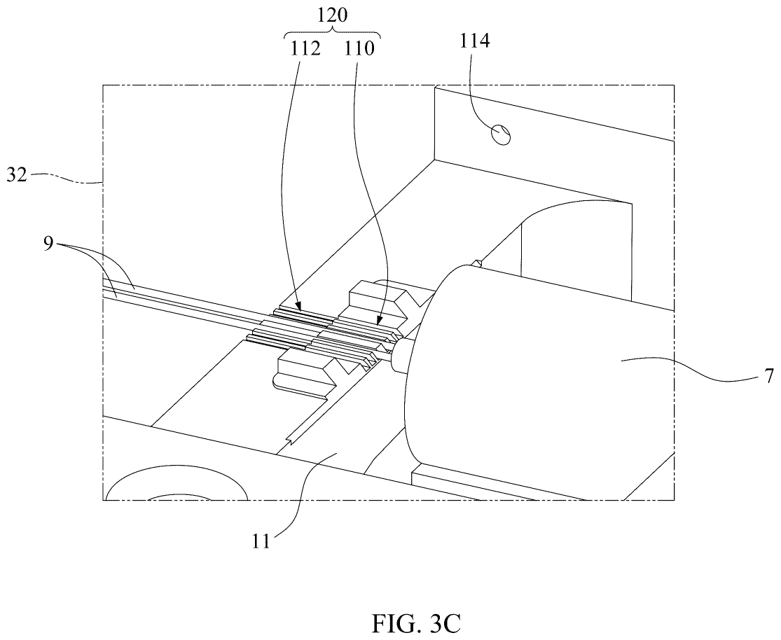

Referring to FIGS. 2A and 2B, FIG. 2A is a front perspective view of the fixing element 13 according to some embodiments of the present disclosure, and FIG. 2B is a rear perspective view of the fixing element 13 according to some embodiments of the present disclosure. The fixing element 13 includes a rod 131, one or more tapered holes 132, and a clamping element 133. The rod 131 includes two opposite ends 131a and 131b. The rod 131 is inserted into the body 11 of the optical fiber fixing structure 1 by insertion of the opposite ends 131a and 131b. In other words, the rod 131 is connected to the body 11 by the insertion of the two opposite ends 131a and 131b into two pivot holes (e.g., the pivot hole 114 of FIG. 3C) of the body 11, respectively. Furthermore, the rod 131 is rotatably disposed on the body 11 of the optical fiber fixing structure 1, i.e., the rod 131 is pivotally mounted on the body 11. The rod 131 further includes an extension part 131c in a middle of one side. The extension part 131c and the tapered holes 132 are disposed on opposite sides of the rod 131. For example, the extension part 131c is disposed on an upper side of the rod 131, and the tapered holes 132 are disposed on a lower side of the rod 131. Each of the tapered holes 132 is used for guiding one optical fiber 9 when the rod 131 is disposed on the optical fiber fixing structure 1. In some embodiments, the fixing element 13 further includes an auxiliary recess 135. The clamping element 133 and the auxiliary recess 135 are disposed on opposite sides of the extension part 131c. For example, the clamping element 133 is disposed on a front side of the extension part 131c, and the auxiliary recess 135 is disposed on a rear side of the extension part 131c. Moreover, the auxiliary recess 135 and the tapered holes 132 are disposed on a same side of the rod 131. In other words, the tapered holes 132 and the clamping element 133 are disposed on opposite sides of the rod 131. For example, the clamping element 133 is disposed on the front side of the rod 131, and the tapered holes 132 are disposed on the rear side of the rod 131. In some embodiments, the clamping element 133 is made of a soft and flexible material which can provide a high coefficient of friction.

Referring to FIGS. 3A, 3B and 3C, FIG. 3A is a partial enlarged view of a region 31 of the optical fiber fixing structure 1 in FIG. 1A according to some embodiments of the present disclosure, and FIG. 3B is a partial enlarged view of a region 32 of the optical fiber fixing structure 1 in FIG. 1B according to some embodiments of the present disclosure. Furthermore, FIG. 3C is a schematic diagram illustrating the region 32 of FIG. 3B with the fixing element 13 removed according to some embodiments of the present disclosure. One or more transition recesses 110 and one or more positioning recesses 112 are formed on the body 11. Each of the tapered holes 132 is used for guiding the optical fibers 9 from the transition recesses 110 to the corresponding positioning recesses 112 when the rod 131 is configured in a first state. In the first state, the rod 131 is rotated to a first angle, so that the clamping element 133 is far away from the body 11 and the positioning recesses 112, i.e., the clamping element 133 is separated from the body 11 and is not in contact with the body 11. A number of the transition recesses 110 is equal to a number of the positioning recesses 112, and a number of the tapered holes 132 is less than the number of the transition recesses 110. In the embodiment of FIGS. 3A, 3B and 3C, the body 11 has six transition recesses 110 and six positioning recesses 112, and the fixing element 13 has two tapered holes 132. In other embodiments, the body 11 may have more or fewer transition recesses 110, more or fewer positioning recesses 112, and more or fewer tapered holes 132.

In some embodiments, each transition recess 110 is connected to a respective positioning recess 112 to form a recess 120, so that the transition recess 110 and the corresponding positioning recess 112 are connected to each other and have a same width and a same depth. In some embodiments, each transition recess 110 and the corresponding (or connected) positioning recess 112 are formed by a same recess 120. Furthermore, a spacing between the transition recesses 110 is same as a spacing between the positioning recesses 112. In some embodiments, the transition recesses 110 have a same width and a same depth. In some embodiments, the transition recesses 110 are divided into multiple groups, and the transition recesses 110 in each group have individual widths and individual depths. A pitch of the optical fibers 9 is determined according to the spacing between the transition recesses 110 (or the spacing between the positioning recesses 112). In some embodiments, the transition recesses 110 have a same spacing. In some embodiments, the transition recesses 110 have different spacings.

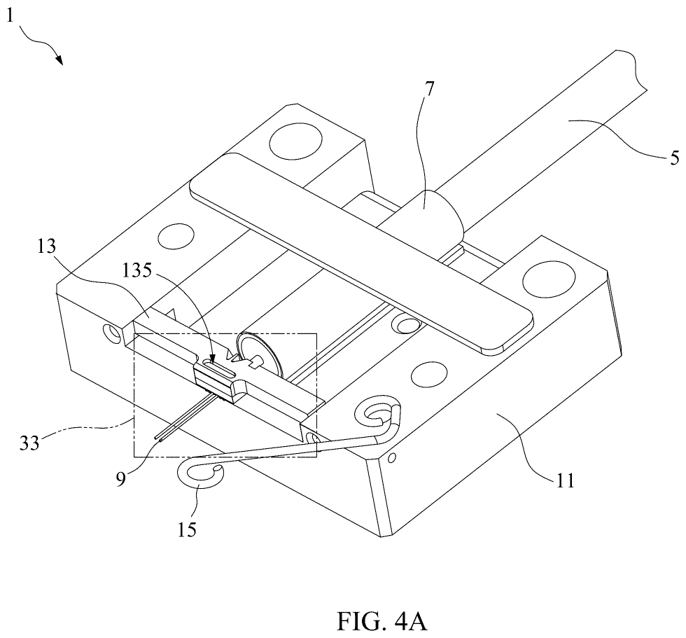

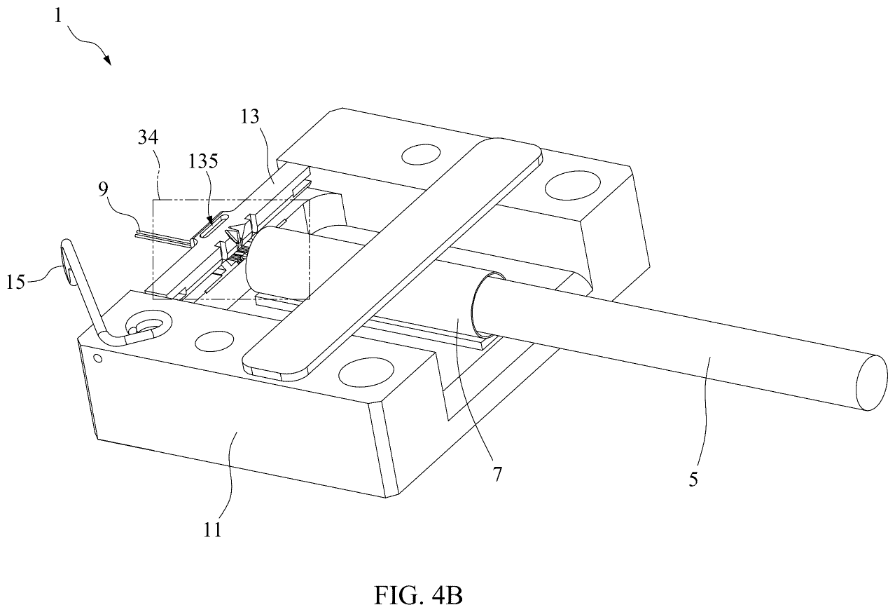

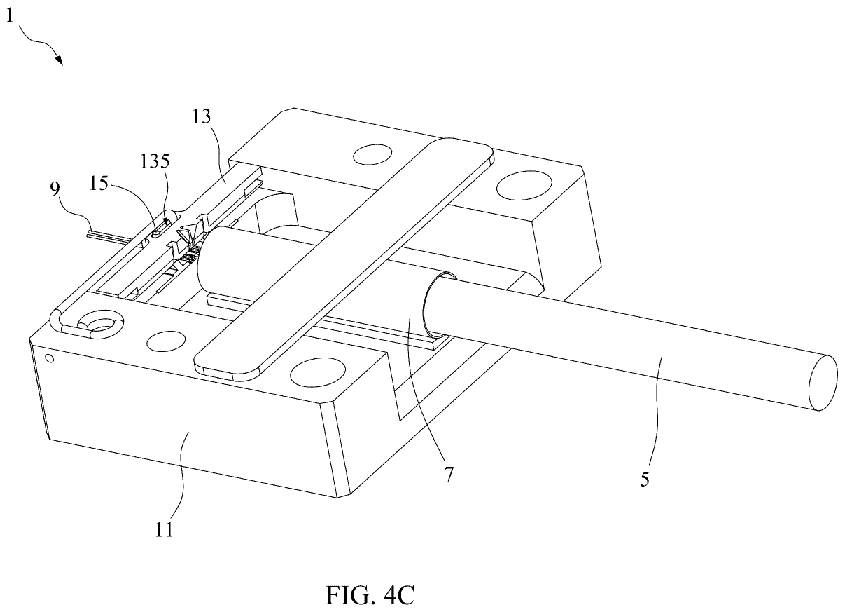

FIG. 4A is a front perspective view of the optical fiber fixing structure 1 and FIG. 4B is a rear perspective view of the optical fiber fixing structure 1 when the rod 131 is configured in a second state according to some embodiments of the present disclosure. In the second state, the rod 131 is rotated to a second angle, so that the clamping element 133 is in contact with the body 11 and overlaps the positioning recesses 112. In some embodiments, a difference between the first angle and the second angle is 90 degrees. In some embodiments, the difference between the first angle and the second angle is between 30 degrees and 120 degrees.

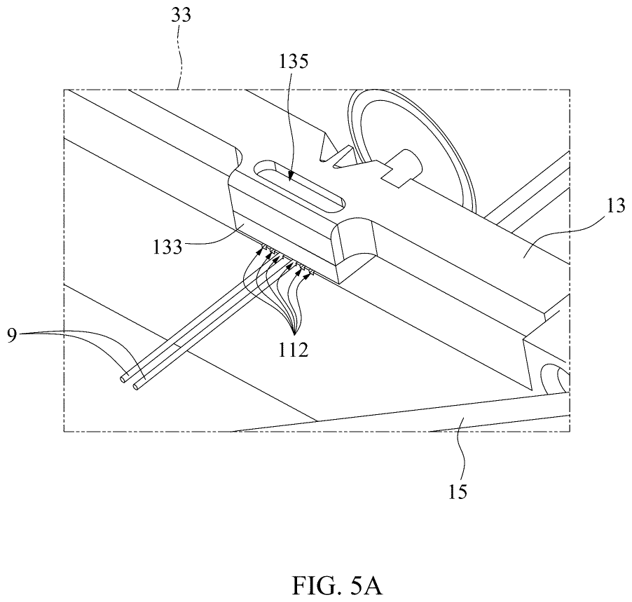

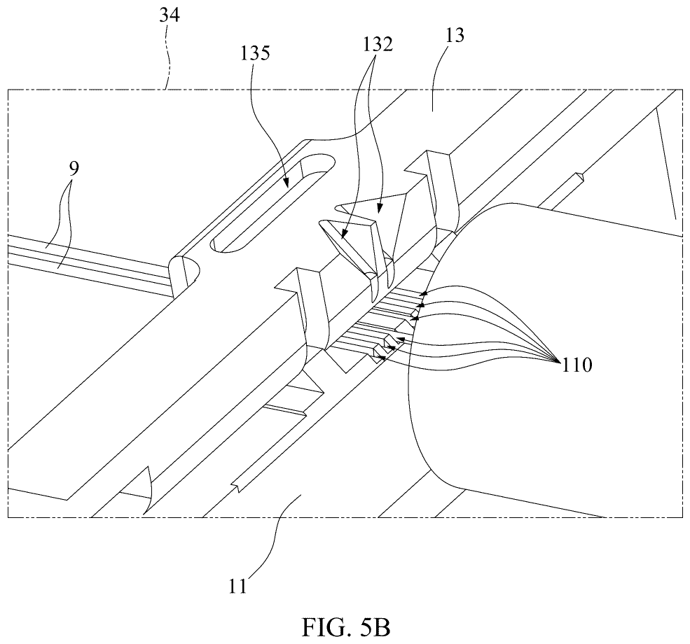

Referring to FIGS. 5A and 5B, FIG. 5A is a partial enlarged view of a region 33 of the optical fiber fixing structure 1 in FIG. 4A according to some embodiments of the present disclosure, and FIG. 5B is a partial enlarged view of a region 34 of the optical fiber fixing structure 1 in FIG. 4B according to some embodiments of the present disclosure. When the rod 131 is rotated to the second angle (i.e., the second state), the auxiliary recess 135 is changed from facing the pipe 7 to facing upward, and the clamping element 133 is changed to face downwards to contact the body 11. Thus, the clamping element 133 is used to clamp the optical fibers 9 between the clamping element 133 and the positioning recesses 112.

The clamping element 133 is made of the soft and flexible material which can provide the high coefficient of friction to prevent damage to the optical fibers 9 while the optical fibers 9 are being clamped. The high friction coefficient material (or soft material) of the clamping element 133 is used to provide a stress treatment mechanism for providing downward pressure to isolate fiber stress and avoid fiber damage. Furthermore, the optical fibers 9 cannot move when clamped by the clamping element 133. As described above, the pitch of the optical fibers 9 is determined according to the spacing between the transition recesses 110 (or the spacing between the positioning recesses 112).

Referring back to FIG. 4C, FIG. 4C is a rear perspective view of the optical fiber fixing structure 1 with the rod 131 rotated to the second angle (i.e., the second state) according to some embodiments of the present disclosure. In FIG. 4C, one end of the auxiliary element 15 is fixed on the body 11, and another end of the auxiliary element 15 is rotated and then inserted into the auxiliary recess 135. Thus, the rod 131 is fixed on the body 11 by the auxiliary element 15, i.e., the rod 131 cannot rotate.

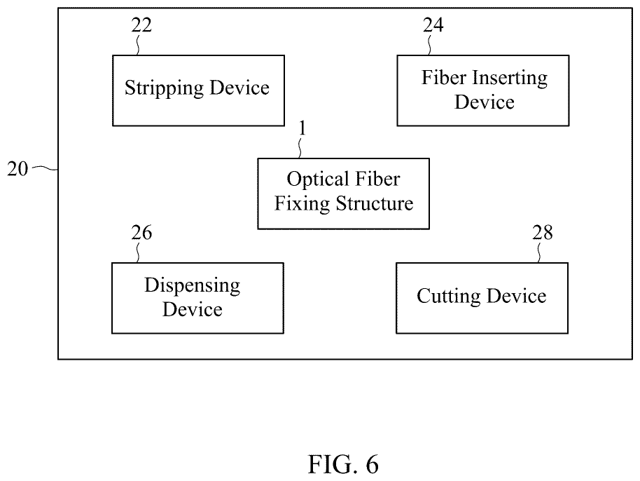

Referring to FIG. 6, FIG. 6 is an optical fiber guiding device 20 according to some embodiments of the present disclosure. The optical fiber guiding device 20 includes the optical fiber fixing structure 1, a stripping device 22, a fiber inserting device 24, a dispensing device 26, and a cutting device 28. As described above, the optical fiber fixing structure 1 is configured to clamp the optical fibers 9 of the cable 5. The stripping device 22 is configured to automatically strip a cover layer (e.g., cladding) off each of the optical fibers 9 clamped by the optical fiber fixing structure 1. The fiber inserting device 24 is configured to align a fiber connector with the stripped optical fibers 9 and move the fiber connector toward the stripped optical fibers 9, so as to insert the stripped optical fibers 9 into the fiber connector. The dispensing device 26 is configured to fix the optical fibers 9 on the fiber connector after the stripped optical fibers 9 are inserted into the fiber connector via corresponding through holes (or corresponding perforations) of the fiber connector by the fiber inserting device 24. The cutting device 28 is configured to cut redundant parts of the optical fibers 9 after the optical fibers 9 are fixed on the fiber connector. In some embodiments, the cutting device 28 is a laser device. The cutting device 28 is further configured to control an endface angle of the cut optical fibers 9. For a purpose of brevity, structural descriptions of the stripping device 22, the fiber inserting device 24, the dispensing device 26 and the cutting device 28 are omitted.

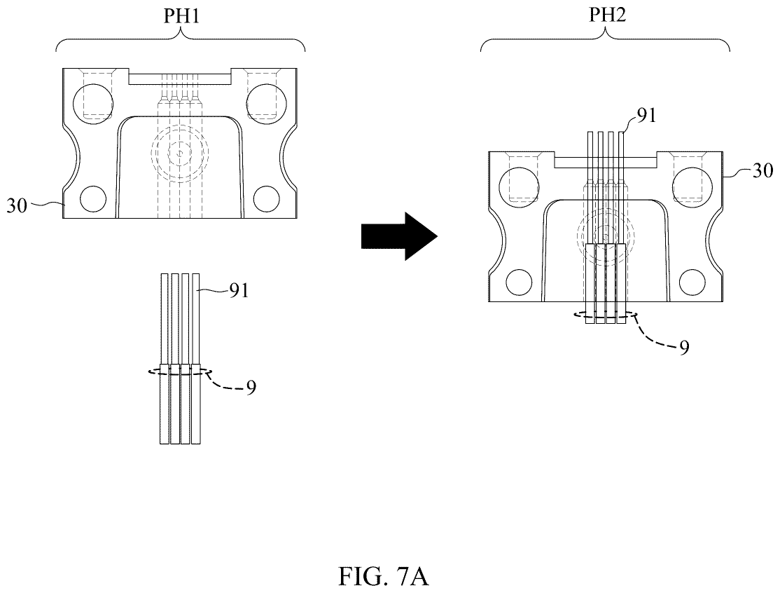

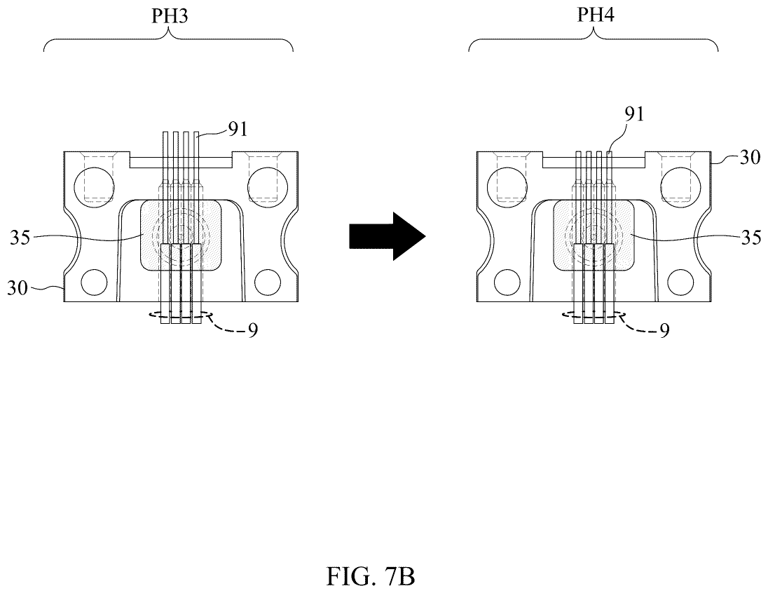

FIG. 7A and FIG. 7B show different phases of operations of connecting the optical fibers 9 to the fiber connector 30 in the optical fiber guiding device 20 of FIG. 6 according to some embodiments of the present disclosure. In order to simplify the description, the optical fiber fixing structure 1, the stripping device 22, the fiber inserting device 24, the dispensing device 26 and the cutting device 28 are omitted in FIGS. 7A and 7B.

In phase PH1 of FIG. 7A, the four optical fibers 9 are clamped by the optical fiber fixing structure 1, and the cover layers are stripped off the clamped optical fibers 9 by the stripping device 22 to expose cores 91 of the optical fibers 9. Simultaneously, the fiber connector 30 is placed into the optical fiber guiding device 20. It should be noted that a number of optical fibers 9 is an example and is not intended to limit the disclosure.

In phase PH2 of FIG. 7A, the stripped optical fibers 9 clamped by the optical fiber fixing structure 1 are inserted into the fiber connector 30 by the fiber inserting device 24. After the stripped optical fibers 9 are inserted, front ends of the cores 91 of the stripped optical fibers 9 pass through corresponding through holes of the fiber connector 30. In other words, the front ends of the cores 91 extend beyond the fiber connector 30.

In phase PH3 of FIG. 7B, a dispensing process is performed by the dispensing device 26. For example, an adhesive 35 is applied to the fiber connector 30 by the dispensing device 26, so as to fix the optical fibers 9 on the fiber connector 30. In the embodiment of FIG. 7B, a portion of the optical fibers 9 that exposes the cores 91 (i.e., an interface between the stripped cover layers and non-stripped cover layers) is completely covered by the adhesive 35. In some embodiments, the dispensing device 26 is a dispenser. In some embodiments, the adhesive 35 is a photo-curable adhesive, and a curing process is performed on the optical fiber guiding device 20, so as to cure the adhesive 35.

In phase PH4 of FIG. 7B, the redundant parts of the stripped optical fibers 9 are cut off, and then the cores 91 of the stripped optical fibers 9 extending beyond the fiber connector 30 are removed, i.e., the front ends of the cores 91 are removed.

In the optical fiber guiding device 20, after the fiber connector 30 and the cable 5 fixed by the optical fiber fixing structure 1 are received, operations of the stripping device 22, the fiber inserting device 24, the dispensing device 26 and the cutting device 28 are automatically performed. Thus, the cover layers are stripped off the optical fibers 9 in the cable 5, and then the optical fibers 9 are aligned and inserted into the fiber connector 30. After the optical fibers 9 inserted into the fiber connector 30 are dispensed, the stripped optical fibers 9 are cut with a controlled endface angle (i.e., so as to control the endface angle), thereby producing the fiber connector 30 combined with the cable 5 including the optical fibers 9. During the operations of the optical fiber guiding device 20, high-precision positioning of the optical fibers 9 and stress control are provided by the optical fiber fixing structure 1 when the operations are applied to the optical fibers 9.

In the present disclosure, the optical fiber fixing structure 1 is configured to clamp the one or more optical fibers 9 to provide high-precision positioning and effective stress control for the one or more optical fibers 9. The optical fiber guiding device 20 is configured to automatically connect the one or more optical fibers 9 clamped by the optical fiber fixing structure 1 to the fiber connector 30, thereby improving assembly efficiency and accuracy when connecting the fiber connector 30 to the one or more optical fibers 9.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture. compositions of matter. means, methods, and steps.

What is claimed is:

1. An optical fiber fixing structure, comprising:
a body, wherein one or more recesses are formed on the body; and
a fixing element, comprising:
a rod, rotatably disposed on the body;
one or more tapered holes for guiding one or more optical fibers to the one or more recesses when the rod is configured in a first state; and
a clamping element, for clamping the one or more optical fibers between the clamping element and the one or more recesses when the rod is configured in a second state.

2. The optical fiber fixing structure of claim 1, wherein the rod comprises two opposite ends, and the rod is connected to the body by insertion of the two opposite ends of the rod into two pivot holes of the body, respectively.

3. The optical fiber fixing structure of claim 1, wherein the one or more recesses comprise one or more transition recesses and one or more positioning recesses, and a number of the one or more transition recesses is equal to a number of the one or more positioning recesses.

4. The optical fiber fixing structure of claim 3, wherein a number of the one or more tapered holes is less than the number of the one or more transition recesses.

5. The optical fiber fixing structure of claim 3, wherein each of the one or more transition recesses connects to one of the one or more positioning recesses.

6. The optical fiber fixing structure of claim 3, wherein a spacing of the transition recesses is equal to a spacing of the positioning recesses.

7. The optical fiber fixing structure of claim 1, wherein the clamping element comprises a material with a high friction coefficient.

8. The optical fiber fixing structure of claim 1, wherein the clamping element is separated from the body when the rod is configured in the first state, and the clamping element is in contact with the body when the rod is configured in the second state.

9. The optical fiber fixing structure of claim 1, wherein the one or more optical fibers are surrounded by a cable jacket.

10. An optical fiber guiding device, comprising:
an optical fiber fixing structure, comprising:
a body, wherein one or more transition recesses and one or more positioning recesses are formed on the body; and
a fixing element, comprising:
a rod, rotatably disposed on the body;
one or more tapered holes for guiding one or more optical fibers from the one or more transition recesses to the one or more positioning recesses when the rod is configured in a first state; and
a clamping element, for clamping the one or more optical fibers between the clamping element and the one or more positioning recesses when the rod is configured in a second state;
a stripping device, for stripping a cover layer off the one or more clamped optical fibers; and
a fiber inserting device, for aligning a fiber connector with the one or more optical fibers and moving the fiber connector toward the one or more optical fibers so that the one or more optical fibers are inserted into the fiber connector after the cover layer of the one or more clamped optical fibers is stripped off.

11. The optical fiber guiding device of claim 10, wherein the rod comprises two opposite ends, and the rod is connected to the body by insertion of the two opposite ends of the rod into two pivot holes of the body, respectively.

12. The optical fiber guiding device of claim 10, wherein each of the one or more transition recesses connects to one of the one or more positioning recesses.

13. The optical fiber guiding device of claim 10, wherein the clamping element comprises a material with a high friction coefficient.

14. The optical fiber guiding device of claim 10, wherein a spacing of the transition recesses is equal to a spacing of the positioning recesses.

15. The optical fiber guiding device of claim 10, wherein the clamping element is separated from the body when the rod is configured in the first state, and the clamping element is in contact with the body when the rod is configured in the second state.

16. The optical fiber guiding device of claim 10, wherein the stripping device is configured to strip the cover layer off the one or more clamped optical fibers to expose a core of the one or more optical fibers.

17. The optical fiber guiding device of claim 10, further comprising:
a dispensing device, for fixing the one or more optical fibers on the fiber connector; and
a cutting device, for cutting the one or more optical fibers after the one or more optical fibers are fixed on the fiber connector.

18. The optical fiber guiding device of claim 17, wherein the dispensing device is configured to apply an adhesive to the fiber connector, so as to fix the one or more optical fibers on the fiber connector.

19. The optical fiber guiding device of claim 18, wherein the adhesive is a photo-curable adhesive.

20. The optical fiber guiding device of claim 17, wherein the cutting device is configured to cut a core of the one or more optical fibers with a controlled endface angle.
